(19) United States
(12) Patent Application Publication
(10) Pub. No.: US 2025/0162560 A1
(43) Pub. Date: May 22, 2025

(54) BRAKE BOOSTER DEVICE, BRAKE SYSTEM, AND VEHICLE

(71) Applicant: Robert Bosch GmbH, Stuttgart (DE)

(72) Inventors: Alice Schacherl, Burgberg (DE); Ben Ferguson, Rettenberg (DE); Bernd Lutz, Kempten (DE); Christoph Voelkel, Waltenhofen (DE); Guenter Escher, Oberstdorf (DE); Ignaz Hatt, Buchenberg (DE); Martin Winkler, Sonthofen (DE); Sven Langhorst, Kempten (DE)

(21) Appl. No.: 18/946,422

(22) Filed: Nov. 13, 2024

(30) Foreign Application Priority Data
Nov. 20, 2023 (DE) 10 2023 211 512.3

(51) Int. Cl. B60T 13/74; B60T 8/1755; B60T 13/14

(52) U.S. Cl. CPC B60T 13/745; B60T 8/1755; B60T 13/145; B60T 13/148

(57) ABSTRACT

A brake booster device. The brake booster includes a reservoir and a master brake cylinder having at least one chamber and at least one piston arranged in the chamber. The chamber can be connected to the pressure regulator so that the piston can be at least partially by returned via the pressure regulator, wherein the chamber can be connected to the reservoir, wherein a valve is arranged between the chamber and the reservoir.

### CROSS REFERENCE

The present application claims the benefit under 35 U.S.C. § 119 of German Patent Application No. DE 10 2023 211 512.3 filed on Nov. 20, 2023, which is expressly incorporated herein by reference in its entirety.

### FIELD

The present invention relates to a brake booster device, to a brake system, and to a vehicle.

### BACKGROUND INFORMATION

European Patent No. EP 2 217 478 B1 shows a brake system with a clutch that can be switched by the brake pedal in order to decouple the drive device from the piston-cylinder unit.

German Patent Application No. DE 10 2010 003 602 A1 relates to a method for controlling/regulating an amplification of a braking force of a brake system.

German Patent Application No. DE 10 2011 006 746 A1 describes a brake system for a vehicle. German Patent Application No. DE 10 2015 213 710 A1 describes an electromechanical brake booster.

### SUMMARY

The present invention provides a brake booster device. According to an example embodiment of the present invention, the brake booster device includes a reservoir and a master brake cylinder having at least one chamber and at least one piston arranged in the chamber is that the chamber can be connected to the pressure regulator so that the piston can be at least partially returned by means of the pressure regulator, wherein the chamber can be connected to the reservoir, wherein a valve is arranged between the chamber and the reservoir.

According to the present invention, the pressure regulator can be used to improve the return capability of the brake booster device. The pressure regulator can be temporarily switched on, in particular in the event of a reduced return force due to increased viscosity of the brake fluid at low temperatures or in the event of failure of a return means. In this case, the valve closes the access to the reservoir, so that the pressure built up by the pressure regulator remains in the chamber. The valve is arranged in such a way that it prevents the brake fluid from flowing back from the chamber into the reservoir when pressure is built up in the chamber by the pressure regulator.

Further advantageous embodiments of the present invention are disclosed herein.

According to an advantageous embodiment of the present invention, the valve is designed as a check valve. The check valve is arranged in such a way that it closes automatically and prevents the brake fluid from flowing back from the chamber into the reservoir when pressure is built up in the chamber by the pressure regulator.

According to an example embodiment of the present invention, it is also advantageous if at least one spring element, which exerts a return force on the piston, is arranged in the chamber. A return during normal operation of the brake booster device can thus be carried out in a compact and cost-effective manner.

Advantageously, no additional spring element is required in the region of a mechanism, in particular outside the chamber, of the brake booster device, so that the brake booster device can be designed to be compact.

According to an example embodiment of the present invention, it is advantageous if the spring element is dimensioned in such a way that a spring force of the spring element is sufficient to return the piston from a braking position to a neutral position during normal operation of the brake booster device. As a result, a spring force acting counter to the braking force can be kept to a minimum.

Advantageously, according to an example embodiment of the present invention, an additional return force can be exerted on the piston by means of the pressure regulator if the spring force of the spring element is not sufficient to return the piston to the neutral position. The pressure regulator can thus be switched on if necessary to return the piston to the neutral position.

According to an example embodiment of the present invention, furthermore, it is advantageous if the spring element is designed as a helical spring arranged on the piston. As a result, the brake booster device can be designed to be compact.

According to a further advantageous example embodiment of the present invention, the brake booster device has an electric motor and a mechanism, by means of which the piston can be deflected and/or returned.

According to an example embodiment of the present invention, it is advantageous if an additional return force can be exerted on the piston by means of the pressure regulator if the return force of the electric motor is not sufficient to return the piston from a braking position to a neutral position. As a result, the pressure regulator can be switched on if necessary to return the piston to the neutral position.

The present invention also provides a brake system. According to an example embodiment of the present invention, the brake system has a brake booster device, in particular as described above according to the present invention or according to the rest of the disclosure herein relating to the brake booster device, a pressure regulator, and a control device, wherein the pressure regulator can be operated by means of the control device.

According to the present invention, the control device is configured to recognize a use case in which the return force acting on the piston is not sufficient to return the piston to the neutral position. Furthermore, the control device is configured to activate the pressure regulator in order to provide sufficient hydraulic pressure to return the piston.

According to an example embodiment of the present invention, it is advantageous if the brake system has a vehicle stability system, wherein the vehicle stability system comprises the pressure regulator and/or the control device. No additional pressure source for returning the piston is thus required. The brake system can be designed to be compact.

The present invention also provides a vehicle. According to an example embodiment of the present invention, the vehicle has a brake booster device as described above or according to the rest of the disclosure herein relating to the brake booster device, and/or a brake system of the present invention as described above.

The present invention provides that the return capability of the brake booster device is improved.

The above embodiments and developments of the present invention may be combined with one another in any reasonable manner. Further possible embodiments, developments, and implementations of the present invention also include combinations not explicitly mentioned of features of the present invention described above or in the following relating to the exemplary embodiments of the present invention. A person skilled in the art will in particular also add individual aspects as improvements or additions to the relevant basic form of the present invention.

### BRIEF DESCRIPTION OF THE DRAWING

Below, the present invention is explained on the basis of an exemplary embodiment, from which further inventive features may arise, but the scope of the present invention is not limited thereto. An exemplary embodiment of the present invention is shown in the figure.

FIG. 1 shows a schematic representation of a brake booster device 1 according to an exemplary embodiment of the present invention.

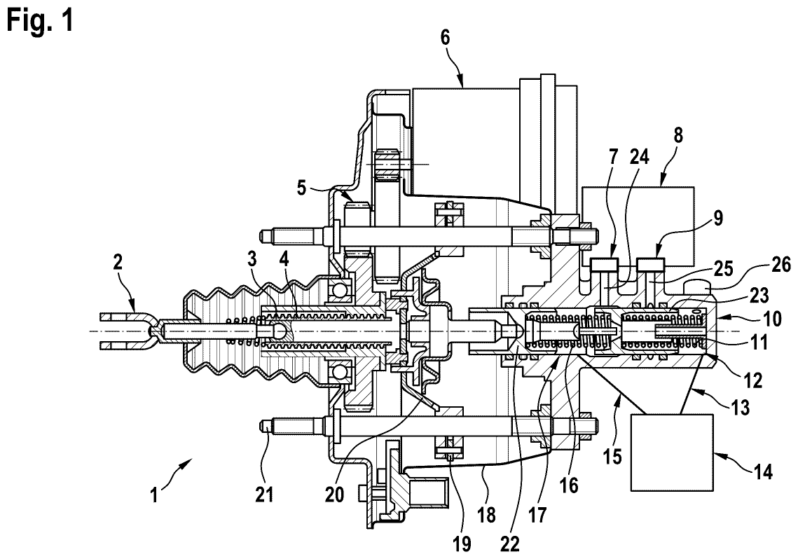

### DETAILED DESCRIPTION OF EXAMPLE EMBODIMENTS

The brake booster device 1 comprises an electric motor 6, a mechanism with a gearing 5, a spindle 4 and a spindle nut 3, as well as a master brake cylinder 10 and a reservoir 8.

In the exemplary embodiment shown in the figure, the master brake cylinder 10 has a first chamber 17 and a second chamber 12 and is thus designed as a tandem master brake cylinder. Alternatively, the master brake cylinder 10 may also have only a single chamber, in which a single piston with a single spring element is arranged.

The master brake cylinder 10 has a first piston 22 and a second piston 23, wherein the first piston 22 is arranged in the first chamber 17 and the second piston 23 is arranged in the second chamber 12. The second piston 23 can be deflected by means of the first piston 22. The first piston 22 is connected to a first spring element 16 and the second piston 23 is connected to a second spring element 11. Each spring element (11, 16) is configured to exert a return force on the relevant piston (22, 23). The spring elements (11, 16) are, for example, designed as helical springs.

The first chamber 17 can be hydraulically connected to the reservoir 8 by means of a first connecting line 24. A first valve 7 is arranged between the first chamber 17 and the reservoir 8.

The second chamber 12 can be hydraulically connected to the reservoir 8 by means of a second connecting line 25. A second valve 9 is arranged between the second chamber 12 and the reservoir 8.

The first valve 7 and/or the second valve 9 is preferably designed in each case as a check valve.

The master brake cylinder 10 is connected by means of at least one supply line 26 to a brake circuit system not shown in the figure. Preferably, each chamber (12, 17) has a relevant supply line 26, which is connected to a relevant brake circuit.

The brake booster device 1 can be actuated by means of an actuating device 2, which can be connected, for example, to a brake pedal. The actuating device 2 is arranged in such a way that a driver braking force applied to the actuating device 2 deflects a spindle 4. The spindle 4 is connected to and deflects the first piston 22.

The actuation may involve adjusting or moving a mechanism, whereby a braking effect on a friction brake can be activated or released; for example, the master brake cylinder 10 of the brake booster device 1 can be returned from a braking position, in which a friction brake is active, to a neutral position.

For amplifying the braking force, the electric motor 6 is configured to drive the spindle nut 3 by means of the gearing 5. The spindle nut 3 is connected to the spindle 4 and is configured to amplify the deflection of the spindle 4. An anti-rotation plate 20 is connected to the spindle and prevents the spindle 4 from rotating with the spindle nut 3. For this purpose, the anti-rotation plate 20 is connected to tie rods 21 by means of bushings 19. When the spindle nut 3 rotates, the anti-rotation plate 20 is guided by means of the tie rods 21 so that the spindle 4 is deflected and a brake pressure is built up in the master brake cylinder 10.

The spindle 4, the spindle nut 3, the gearing 5, and the anti-rotation plate 20 are arranged in a housing 18.

The brake booster device 1 is connected to a pressure regulator 14. For this purpose, a first supply line 15 is arranged between the first chamber 17 and the pressure regulator 14. A second supply line 13 is arranged between the second chamber 12 and the pressure regulator 14.

Each supply line (13, 15) extends through a cylinder housing of the master brake cylinder 10. Each supply line (13, 15) is arranged in such a way that a volume flow can flow from the pressure regulator 14 into the relevant chamber (12, 17) in any position of the relevant piston (22, 23).

The pressure regulator 14 can be comprised by the brake booster device 1, be arranged externally thereto and represent an independent apparatus, or a driving stability system (ESP) can assume the role of the pressure regulator 14 (if a plurality of pressure regulators is present, the ESP can then also be designated as a further pressure regulator).

The pressure regulator 14 can be connected to or comprise a pump and a storage apparatus for a hydraulic fluid and can bring about a certain volume of fluid to build up or reduce a certain pressure at the master brake cylinder 10, with which a pressure can be generated at the master brake cylinder 10 against the movement for the braking effect.

The pressure regulator 14 is operated by a control device not shown in the figures. The control device can be designed as a component of the brake booster device 1 or separately from the brake booster device 1; it may, for example, be a control device of a driving stability system (ESP).

The pistons (22, 23) in the master brake cylinder 10 can thus be returned by means of the hydraulic pressure built up by the pressure regulator 14. The pressure regulator 14 supports the spring elements (11, 16) in returning the pistons (22, 23). The return force acting on the pistons (22, 23) is thus the sum of the spring force of the first spring element 16 and the spring force of the second spring element 11 and the hydraulic force of the pressure regulator 14.

The spring elements (11, 16) are dimensioned in such a way that the spring force of the spring elements (11, 16) during normal operation of the brake booster device 1 is sufficient to return the pistons (22, 23) to the neutral position, in which no braking force acts on the brake circuit system, after a braking process has been completed. In the use case in which the spring force of the spring elements (11, 16) is not sufficient to return the pistons (22, 23), the pressure regulator 14 is additionally activated, which generates an additional pressure on the pistons (22, 23), which returns the pistons (22, 23). This use case occurs, for example, at low temperatures, which cause increased viscosity of the brake fluid.

Alternatively, there may be a failure of the electric motor 6, which can actuate a return of the brake booster device 1 during normal operation.

The control device is configured to ascertain a pressure in the master brake cylinder 10 and to compare it to a predetermined cylinder pressure, wherein a preceding braking process and the need for the return are recognized when the pressure in the master brake cylinder 10 is greater than or equal to the predetermined cylinder pressure and there is no driver braking request.

In this case, a high internal pressure may remain in the chambers (12, 17), which is to be reduced, advantageously through a return. Firstly, a residual pressure in the chambers (12, 17) automatically pushes the pistons (22, 23) back until the force of the hydraulic pressure on the pistons (22, 23) and the frictional forces in the mechanism and in the connected gearing 5 balance out. In order to push the mechanism and the pistons (22, 23) further back toward the neutral position, a volume flow in the master brake cylinder 10 can be maintained, for example by a pump of the pressure regulator 14 or of a pressure controller. This allows a return force to be achieved in the pistons (22, 23) which is greater than the frictional forces.

The control device is configured to infer the presence of a driver braking request by means of information about a standstill of the vehicle and/or by means of a pedal position of a gas pedal and/or by means of a position of a brake pedal on the vehicle and/or by means of ascertaining a speed and/or a speed gradient of the vehicle.

The signals Ih the control device can receive to activate the return function, in particular to operate the pressure regulator 14 for returning, can be information about the presence of a driver braking request, a measured master brake cylinder pressure, an active brake light switch (which is used to infer a braking request), a gas pedal position, which can indicate whether acceleration (i.e., not braking) or braking should take place, or standstill information about the vehicle.

What is claimed is:

1. A brake booster device, comprising:
a reservoir; and
a master brake cylinder having at least one chamber and at least one piston arranged in the chamber, wherein the chamber can be connected to a pressure regulator so that the piston can be at least partially returned using the pressure regulator, wherein the chamber can be connected to the reservoir, and wherein a valve is arranged between the chamber and the reservoir.

2. The brake booster device according to claim 1, wherein the valve is a check valve.

3. The brake booster device according to claim 1, wherein at least one spring element, which exerts a return force on the piston, is arranged in the chamber.

4. The brake booster device according to claim 3, wherein the spring element is dimensioned in such a way that a spring force of the spring element is sufficient to return the piston from a braking position to a neutral position during normal operation of the brake booster device.

5. The brake booster device according to claim 4, wherein an additional return force can be exerted on the piston using the pressure regulator when the spring force of the spring element is not sufficient to return the piston to the neutral position.

6. The brake booster device according to claim 3, wherein the spring element is a helical spring, which is arranged on the piston.

7. The brake booster device according to claim 1, wherein the brake booster device has an electric motor and a mechanism, using which the piston can be deflected and/or returned.

8. The brake booster device according to claim 7, wherein an additional return force can be exerted on the piston using the pressure regulator when the return force of the electric motor is not sufficient to return the piston from a braking position to a neutral position.

9. A brake system, comprising:
a brake booster device;
a pressure regulator; and
a control device, wherein the pressure regulator can be operated by the control device;
wherein the brake booster device includes:
a reservoir, and
a master brake cylinder having at least one chamber and at least one piston arranged in the chamber, wherein the chamber can be connected to the pressure regulator so that the piston can be at least partially returned using the pressure regulator,
wherein the chamber can be connected to the reservoir, and wherein a valve is arranged between the chamber and the reservoir.

10. The brake system according to claim 9, wherein the brake system further comprises a vehicle stability system, wherein the vehicle stability system includes the pressure regulator and/or the control device.

11. A vehicle, comprising:
a brake system, including:
a brake booster device,
a pressure regulator, and
a control device, wherein the pressure regulator can be operated by the control device,
wherein the brake booster device includes:
a reservoir, and
a master brake cylinder having at least one chamber and at least one piston arranged in the chamber, wherein the chamber can be connected to the pressure regulator so that the piston can be at least partially returned using the pressure regulator, wherein the chamber can be connected to the reservoir, and wherein a valve is arranged between the chamber and the reservoir.
